(19) United States
(12) Patent Application Publication
(10) Pub. No.: US 2023/0093295 A1
(43) Pub. Date: Mar. 23, 2023

(54) Optical IQ Modulator

(71) Applicant: Nippon Telegraph and Telephone Corporation, Tokyo (JP)

(72) Inventors: Shota Kita, Tokyo (JP); Masaya Notomi, Tokyo (JP); Akihiko Shinya, Tokyo (JP); Kengo Nozaki, Tokyo (JP); Kenta Takata, Tokyo (JP)

(21) Appl. No.: 17/798,816

(22) PCT Filed: Feb. 20, 2020
(86) PCT No.: PCT/JP2020/006842

§ 371 Date: Aug. 10, 2022

(51) Int. Cl. G02F 1/225; H04B 10/556

(52) U.S. Cl. CPC G02F 1/225; H04B 10/556

(57) ABSTRACT

An optical IQ modulator includes Y branching elements each of which has one input and two outputs and which are cascade-connected, QQPSK modulators each of which performs QPSK modulation on a corresponding one of continuous beams of light branched by the Y branching elements so that four signal points are present in a first quadrant on an IQ plane, Y combining elements each of which has two inputs and one output and which are cascade-connected, a phase modulator that modulates output light of the Y combining element in accordance with a drive signal Z, and a phase modulator that modulates output light of the phase modulator in accordance with a drive signal W.

### CROSS-REFERENCE TO RELATED APPLICATIONS

This application is a national phase entry of PCT Application No. PCT/JP2020/006842, filed on Feb. 20, 2020, which application is hereby incorporated herein by reference.

### TECHNICAL FIELD

The present invention relates to an optical IQ modulator capable of generating a high gradation signal.

### BACKGROUND

Optical coherent communication technologies using an IQ modulation scheme in which signal amplitudes and phases are subjected to binary modulation or multi-value modulation have increasingly been put into practical use in recent years and have supported an increase in capacity of core communication. There are various formats of IQ modulation schemes. Thus, many dedicated or general-purpose optical transceivers that are compatible with each format, known as optical IQ modulators, have been proposed, developed, and used. Many of these optical IQ modulators have a configuration in which a plurality of Mach-Zehnder interferometers (MZIs) are connected in parallel or in series.

The emergence and development of Si photonics have activated a trend to integrate a large number of optical switches on chips. For example, optical circuits have been developed in which matrix optical switches with a size of equal to or greater than 32×32 and the like are integrated with high precision. Also, many of trends of using light not only for optical communication applications but also for arithmetic operations have been observed simultaneously in the world in response to such a trend of increase in scale of integration.

Advantages of utilization of light for arithmetic operations are as follows.

(a) A signal propagation speed is a light speed and thus a system having a small operation delay (latency) can be achieved.

(b) It is possible to highly efficiently perform a vector operation and Fourier transform, which require high costs in electric circuits, only through transmission of optical signals within a linear optical circuit.

For electric circuits, degrees of integration have been enhanced by thoroughly pursuing fine design, and throughputs per chip area have been improved. However, because wiring resistances and capacities increase as side effects of the fine design of the electric circuits, latency has kept increasing due to a significant increase in CR delay.

On the other hand, optical circuits can reduce latency because there is no CR delay and sizes of optical switches have been reduced with advancement of photonics technologies in recent years. Thus, optical operations are considered to be important for applications specialized in low latency properties.

In recent years, it has become known that about 90% of power consumption is occupied by vector operations in neural network accelerators that have attracted attention around the world with trends of artificial intelligence (AI). In order to highly efficiently perform the vector operations using light, optical neural network (ONN) accelerators have been proposed in which analog optical switches are cascade-connected.

For the ONN accelerators, studies for demonstrating principles have been carried out in the field of early sound recognition and the like. Further, because the ONN is one kind of complex-valued neural network (NN), it is possible to cause two pieces of analog information to be included in one input by using an amplitude and a phase or two components of an I axis and a Q axis.

An input of the ONN requires optical IQ modulators, the number of which corresponds to the number of input channels. As to optical analog signals generated by the optical IQ modulators, a given amplitude and a given phase or a given I component and a given Q component can be ideally specified, but gradations of the analog signals output by the practical optical IQ modulators are finite. In order to secure operation accuracy, gradations of optical analog signals to be input to the ONN are needed to be high to some extent. For example, even the Mixed National Institute of Standards and Technology (MNIST) database, which is a significantly basic letter recognition image set, includes gray-scale images of 256 gradations.

Although it is necessary to separately inspect how much gradations of optical analog signals affect operation accuracy in each application field, it is meaningful to achieve optical IQ modulators that enable high-gradation inputs to the ONN in order to prevent the input side from having a disadvantage that leads to degradation of operation accuracy.

Optical IQ modulators for communication applications have an old history, and various configurations have been proposed. Representative modulation schemes include amplitude phase shift keying (APSK) and quadrature amplitude modulation (QAM). In a case in which high-order inputs to the ONN are needed, APSK is not appropriate as an input format for the ONN because phase setting becomes rougher for larger amplitude values, which leads to poor balance. QAM allows for finer phase setting for larger amplitude values and is excellent in terms of uniformity and maintenance of a signal-to-noise ratio (SNR). In the embodiments of the present invention, it is assumed that QAM is achieved using an optical IQ modulator.

In communication applications, 16QAM, 32QAM, 64QAM and the like are used as high-order multi-value modulation (see Non-Patent Literature 1). A required SNR level significantly increases for high-order QAM of 64QAM or more, and thus, in a current situation, such high-order QAM has hardly been considered for communication applications that assume a situation in which light attenuation and environmental noise are large. However, in arithmetic operation or communication for a short distance such as between chips or on a chip, it is possible to substantially ignore reduction of the SNR, and there is thus a high likelihood that utilization of higher gradation communication formats will be further studied and an importance thereof will increase.

Various configurations for optical IQ modulators that achieve higher-order QAM have been proposed. In order for a single configuration to deal with a plurality of communication formats, many configurations have a tendency to place priority on reconfigurability in a current situation. Implementation of multi-value modulation that exceeds the current level on the optical circuit side is not assumed from the beginning, and an increase in gradation is assumed to be achieved by multi-valuing using a digital signal processor (DSP) and a digital-to-analog converter (DAC) on an electrical side.

If multi-value modulation is implemented with a configuration of optical IQ modulators known in the current situation, for example, a configuration in which optical IQ modulators are cascade-connected, an increase in gradation may be accompanied not only by an increase in light attenuation, that is, an insertion loss, but also by accumulation of electrical noise on the input side. In other words, it is not possible to expect a drastic improvement in communication capacity per unit power on a short-distance scale as long as the current configuration is used. If DSP and DAC are assumed be frequently used for an ONN application, this results in an inefficient configuration, and there is a concern that such a configuration cannot be distinguished from NN using a complementary metal oxide semiconductor (CMOS).

### CITATION LIST

### Non Patent Literature

Non-Patent Literature 1: Zhen Qu, Ivan B. Djordjevic, Jon Anderson, “Two-Dimensional Constellation Shaping in Fiber-Optic Communications”, Applied Sciences, 2019, 9, 1889

### SUMMARY

### Technical Problem

In embodiments of the present invention has been made in order to solve the aforementioned problems, and an object thereof is to provide an optical IQ modulator capable of achieving a high-order QAM modulator with a low loss and high noise resistance.

### Means for Solving the Problem

An optical IQ modulator according to embodiments of the present invention includes: N first Y branching elements, N being an integer equal to or greater than two, each of the N first Y branching elements having one input and two outputs and being configured to equally split input light into two beams of light; N first modulators, each of the N first modulators being configured to perform QPSK modulation on a corresponding one of N continuous beams of light branched by the N first Y branching elements to generate signal light; N first Y combining elements, each of the N first Y combining elements having two inputs and one output and being configured to use the signal light generated by a corresponding one of the N first modulators as an input, a second modulator configured to perform phase modulation on signal light output from a most downstream one of the N first Y combining elements in accordance with a first drive signal; and a third modulator configured to perform phase modulation on signal light output from the second modulator in accordance with a second drive signal, wherein the N first Y branching elements are cascade-connected such that each of the N first Y branching elements except for a most upstream one of the N first Y branching elements using a single continuous beam of light as an input uses, as an input, light output from a first optical output port of two optical output ports of an upstream one of the N first Y branching elements, output light obtained from a second optical output port of the two optical output ports of each of the N first Y branching elements is used as input light to a corresponding one of the N first modulators, each of the N first modulators performs QPSK modulation on the input continuous light in accordance with a bit for generating an I component and a bit for generating a Q component in an N×2-bit electrical digital signal, the N first Y combining elements are cascade-connected such that each of the (N−1) first Y combining elements except for a most upstream one of the N first Y combining elements uses light output from an optical output port of an upstream one of the N first Y combining elements as input light to a first optical input port, and each of the N first Y combining elements including the most upstream first Y combining element uses signal light generated by a corresponding one of the N first modulators as input light to a second optical input port, and output light obtained from the third modulator is output as QAM signal light.

### Effects of Embodiments of the Invention

According to embodiments of the present invention, the N first Y branching elements, each of which has one input and two outputs, are cascade-connected, the N first Y combining elements, each of which has two inputs and one output, are cascade-connected, and the N first modulators are provided, each of which performs QPSK modulation on a corresponding one of continuous beams of light branched by the N first Y branching elements to generate signal light to the second optical input port of the first Y combining element. Further, the second modulator and the third modulator are provided, the second modulator performs phase modulation on signal light output from the most downstream first Y combining element, and the third modulator performs phase modulation on signal light output from the second modulator. Thus, it is possible to achieve a high-order QAM modulator having lower loss and higher noise resistance than the one in the related art.

Embodiments of the present invention reduces an insertion loss in response to an increase in gradation, that is, an increase in the number of input bits. Moreover, according to the present invention, it is possible to curb accumulation of noise and to improve an SNR because electro-optical modulators are not cascade-connected. Although multi-value modulation of an optical IQ modulator typically requires DSP and DAC in many cases, a DAC part is absorbed on the optical circuit side in embodiments of the present invention. In other words, an optical QAM signal is generated directly from an electrical digital signal, and it is thus possible to eliminate the DSP and the DAC. According to embodiments of the present invention, it is thus possible to expect reduction of power consumption and a circuit area.

### BRIEF DESCRIPTION OF THE DRAWINGS

FIG. 1 is a block diagram illustrating a configuration of an optical IQ modulator according to a first embodiment of the present invention.

FIG. 2 is a diagram illustrating a constellation of an optical output signal of the optical IQ modulator according to the first embodiment of the present invention on an IQ plane.

FIG. 3 is a block diagram illustrating a configuration of a QQPSK modulator according to the first embodiment of the present invention.

FIG. 4 is a diagram illustrating a constellation of an optical output signal of the QQPSK modulator according to the first embodiment of the present invention on an IQ plane.

FIG. 5 is a diagram illustrating a constellation of an optical output signal of a most downstream Y combining element according to the first embodiment of the present invention on an IQ plane.

FIG. 6 is a diagram illustrating a constellation of an optical output signal of a phase modulator according to the first embodiment of the present invention on an IQ plane.

FIG. 7 is a block diagram illustrating a configuration of an optical IQ modulator according to a second embodiment of the present invention.

FIG. 8 is a diagram illustrating a constellation of an optical output signal of an optical I/Q modulator according to the second embodiment of the present invention on an IQ plane.

FIG. 9 is a diagram illustrating a constellation of an optical output signal of a most downstream Y combining element according to the second embodiment of the present invention on an IQ plane.

FIG. 10 is a diagram illustrating a constellation of an optical output signal of a phase modulator according to the second embodiment of the present invention on an IQ plane.

FIG. 11 is a diagram illustrating the maximum output amplitudes of the optical IQ modulators according to the first and second embodiments of the present invention with respect to the number of QQPSK modulators.

FIG. 12 is a block diagram illustrating a configuration of an optical IQ modulator in the related art.

FIG. 13 illustrates excess losses of the optical IQ modulator in the related art and the optical IQ modulator according to the first embodiment of the present invention with reference to an excess loss of the optical IQ modulator according to the second embodiment of the present invention.

FIG. 14 is a block diagram illustrating a configuration of an optical circuit used to inspect operations of the optical I/Q modulators according to the first and second embodiments of the present invention.

FIGS. 15A and 15B are diagrams illustrating constellations of simulation results on an IQ plane when the optical IQ modulators according to the first and second embodiments of the present invention are inserted into the optical circuit of FIG. 14.

FIGS. 16A and 16B are diagrams illustrating utilization forms when the optical IQ modulators according to the first and second embodiments of the present invention are used in an optical accelerator.

### DETAILED DESCRIPTION OF ILLUSTRATIVE EMBODIMENTS

### First Embodiment

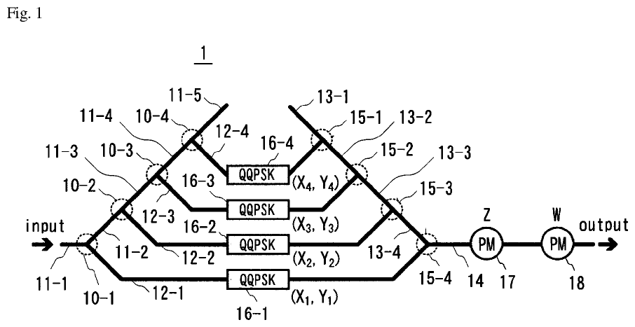

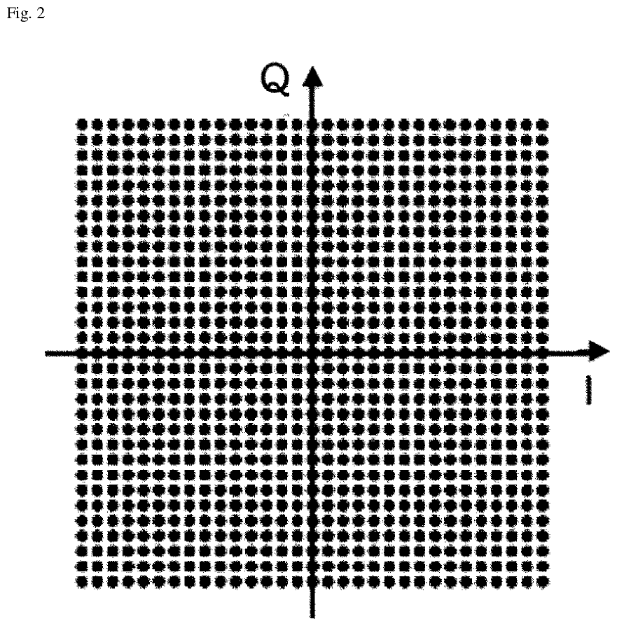

Hereinafter, embodiments of the present invention will be described with reference to the drawings. FIG. 1 is a block diagram illustrating a configuration of an optical IQ modulator according to a first embodiment of the present invention, and FIG. 2 is a diagram illustrating a constellation of an optical output signal of the optical I/Q modulator on an IQ plane. An optical IQ modulator 1 of the present embodiment functions as a 961QAM modulator that generates a 961QAM signal.

Specifically, the optical IQ modulator 1 includes: N Y branching elements 10-1 to 10-N (N is an integer equal to or greater than two and is four in the present embodiment), each of which has one input and two outputs and which are cascade-connected; an optical waveguide 11-1 connected to an optical input port of the Y branching element 10-1 in the first stage; an optical waveguide 11-M (M is an integer equal to or greater than two and equal to or less than N) connecting one of optical output ports of a Y branching element 10-(M−1) in an (M−1)-th stage to an optical input port of a Y branching element 10-M in an M-th stage and inputting light output from the Y branching element 10-(M−1) to the Y branching element 10-M; an optical waveguide 11-(N+1) connected to one of the optical output ports of the Y branching element 10-N in the final stage; optical waveguides 12-1 to 12-N connected to the other optical output ports of the Y branching elements 10-1 to 10-N; N Y combining elements 15-1 to 15-N, each of which has two inputs and one output and which are cascade-connected such that one of optical input ports is connected to a corresponding one of the optical waveguides 12-N to 12-1 and the other one of the optical input ports is connected to an optical output port of a Y combining element in a previous stage; an optical waveguide 13-1 connected to the other one of the optical input ports of the Y combining element 15-1 in the first stage; an optical waveguide 13-M connecting an optical output port of a Y combining element 15-(M−1) in the (M−1)-th stage to the other one of the optical input ports of a Y combining element 15-M in the M-th stage and inputting light output from the Y combining element 15-(M−1) to the Y combining element 15-M; an optical waveguide 14 connected to an optical output port of the Y combining element 15-N in the final stage; quadrant-quadrature phase shift keying (QQPSK) modulators 16-1 to 16-N provided at the optical waveguides 12-1 to 12-N and modulating input continuous light in accordance with bits X for generating an I component and bits Y for generating a Q component in an N×2-bit electrical digital signal; a phase modulator (PM) 17 modulating the signal light propagated through the optical waveguide 14 in accordance with a drive signal Z for selecting between no rotation and 180-degree rotation of the signal on the IQ plane; and a phase modulator 18 modulating the signal light propagated through the optical waveguide 14 in accordance with a drive signal W for selecting between no rotation and 90-degree rotation of the signal on the IQ plane.

As the Y branching elements 10-1 to 10-N, the optical waveguides 11-1 to 11-(N+1), 12-1 to 12-N, 13-1 to 13-N, 14, and the Y combining elements 15-1 to 15-N, for example, dielectric optical wiring such as a planar lightwave circuit (PLC) or semiconductor optical wiring such as an Si thin wire can be used.

Each Y branching element 10-i (i is an integer equal to 1 to N) equally splits propagation light of the optical waveguide 11-i into two beams of light (branching ratio of 1:1). In this manner, each Y branching element 10-i is cascade-connected such that each Y branching element except for the most upstream Y branching element 10-1 using a single continuous beam of light as an input uses light output from one of the two optical output ports of the upstream Y branching element as an input.

In this manner, the continuous light input to the most upstream Y branching element 10-1 from a single continuous laser light source (not illustrated) is split into N continuous beams of light. Also, light intensity differences can be applied to the N continuous beams of light such that each of (N−1) continuous beams of light propagated through a corresponding optical waveguide 12-k (k is an integer from 1 to N−1) has a light intensity that is double (3 dB) the optical intensity of continuous light propagated through the adjacent optical waveguide 12-(k+1) on a lower bit side.

The QQPSK modulator 16-i (i=1 to N) performs modulation such that a phase of continuous light propagated through the optical waveguide 12-i has four values in accordance with corresponding two-bit inputs Xᵢ and Yᵢ of the electrical digital signal.

In typical QPSK modulation, light is modulated so that one signal point is present in each of the four quadrants on the IQ plane. On the other hand, in embodiments of the present invention, light is modulated so that four signal points are present in the first quadrant on the IQ plane, and thus such modulation is called QQPSK. In this QQPSK modulation, signal points are present on the I-axis and the Q-axis, and thus the QAM signal has a zero point as described later.

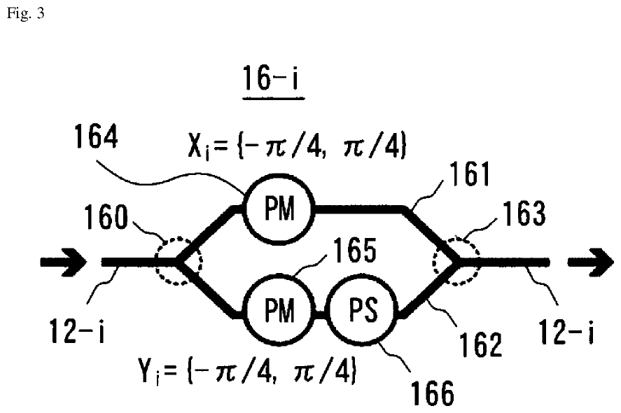

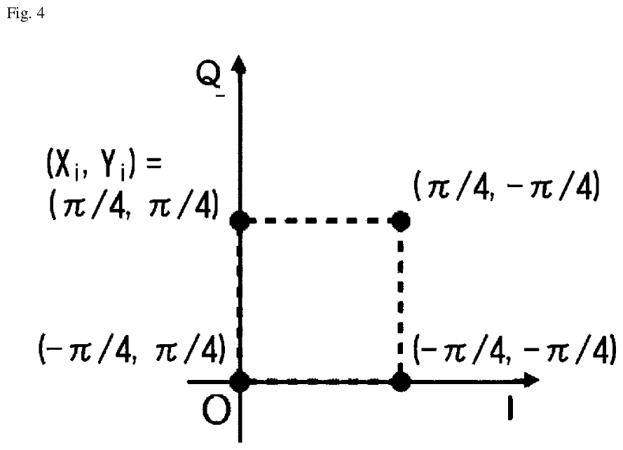

FIG. 3 is a block diagram illustrating the configuration of the QQPSK modulator 16-i, and FIG. 4 is a diagram illustrating a constellation of the optical output signal of the QQPSK modulator 16-i on an IQ plane. The QQPSK modulator 16-i includes a Y branching element 160 having one input and two outputs in which an optical input port is connected to the optical waveguide 12-i, an optical waveguide 161 connected to one of the optical output ports of the Y branching element 160, an optical waveguide 162 connected to the other one of the optical output ports of the Y branching element 160, a Y combining element 163 having two inputs and one output in which one optical input port is connected to the optical waveguide 161 and the other optical input port is connected to the optical waveguide 162, a phase modulator 164 provided at the optical waveguide 161, a phase modulator 165 provided at the optical waveguide 162, and a phase shifter 166 provided at the optical waveguide 162.

The Y branching element 160 equally splits light propagated through the optical waveguide 12-I into two beams of light. The phase modulator 164 outputs continuous light propagated through the optical waveguide 161 with the phase shifted by −π/4 in a case in which the corresponding bit Xᵢ of the electrical digital signal is “0” and outputs the continuous light propagated through the optical waveguide 161 with the phase shifted by π/4 in a case in which the bit Xᵢ is “1.” In this manner, a phase, namely −π/4 or π/4, is individually allocated to the continuous light propagated through the optical waveguide 161 in accordance with the bit Xᵢ of the electrical digital signal.

Similarly, the phase modulator 165 outputs continuous light propagated through the optical waveguide 162 with the phase shifted by −π/4 in a case in which the corresponding bit Yᵢ of the electrical digital signal is “0” and outputs the continuous light propagated through the optical waveguide 162 with the phase shifted by π/4 in a case in which the bit Yᵢ is “1.”

Among N-bit electrical digital signals X₁, X₂, X₃, and X₄, X₁ is the least significant bit (LSB), and X₄ is the most significant bit (MSB). Similarly, among N-bit electrical digital signals Y₁, Y₂, Y₃, and Y₄, Y₁ is the LSB, and Y₄ is the MSB.

The phase shifter 166 outputs the light modulated by the phase modulator 165 with the phase shifted by π/2.

The Y combining element 163 combines the light propagated through the optical waveguide 161 and the light propagated through the optical waveguide 162 at an equal ratio and outputs the combined light.

The QQPSK modulator 16-i thus generates signal light to one of the optical input ports of the Y combining element 15-i.

The optical waveguide 13-1 deals with a zero input. In other words, no light is input to the optical waveguide 13-1.

The Y combining element 15-i combines the light propagated through the optical waveguide 13-i and the light propagated through the optical waveguide 12-j (j=N−i+1) at an equal ratio (combining ratio of 1:1) and outputs the combined light. In this manner, the Y combining elements 15-i are cascade-connected such that each of the Y combining elements uses the signal light modulated by the QQPSK modulator 16-j as one optical input and each of the Y combining elements except for the most upstream Y combining element 15-1 uses the light output from the optical output port of the upstream Y combining element as the other optical input.

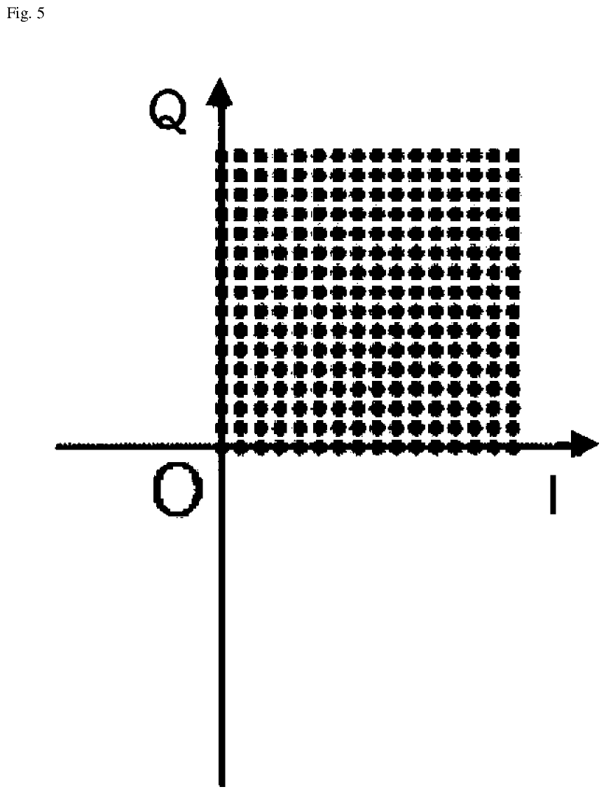

When the I component and the Q component of the output of the Y combining element 15-N are coherent-detected and plotted on the IQ plane, the signal as illustrated in FIG. 5 is obtained. In this way, the signal of the first quadrant on the IQ plane can be generated by the configuration in which the QQPSK modulators 16-1 to 16-N are connected in parallel.

Next, when the drive signal Z has the first voltage, the phase modulator 17 outputs the signal light output from the Y combining element 15-N and propagated through the optical waveguide 14 without changing the phase, and outputs the signal light propagated through the optical waveguide 14 with the phase shifted by a when the drive signal Z has the second voltage.

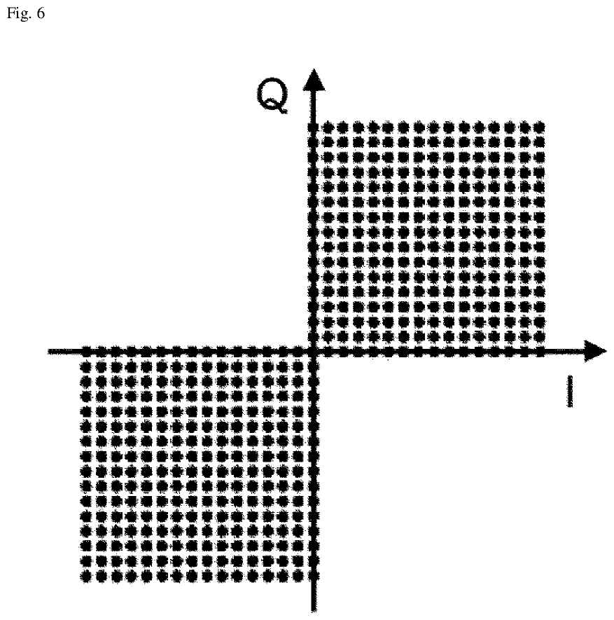

When the I component and the Q component of the output of the phase modulator 17 are coherent-detected and plotted on the IQ plane, the signal is obtained as illustrated in FIG. 6. In this way, the signal in the first quadrant on the IQ plane illustrated in FIG. 5 can be selectively rotated by 180 degrees by the phase modulator 17.

When the drive signal W has the first voltage, the phase modulator 18 outputs the signal light output from the phase modulator 17 and propagated through the optical waveguide 14 without changing the phase, and outputs the signal light propagated through the optical waveguide 14 with phase shifted by π/2 when the drive signal W has the second voltage. In this way, the signals in the first quadrant and the third quadrant on the IQ plane illustrated in FIG. 6 can be selectively rotated by 90 degrees by the phase modulator 18.

When the I component and the Q component of the output of the phase modulator 18 are coherent-detected and plotted on the IQ plane, a 31×31 QAM signal with signal points being present in all quadrants is obtained as illustrated in FIG. 2.

In the present embodiment, at least one of the I component or the Q component can be zero (the 16th and 17th signal points of 32×32 overlap). The reason why the zero point is required for the I component and the Q component is that the zero input (quenching) may be important in optical arithmetic applications such as ONN.

The calibration method of the present embodiment is as follows. First, the following four patterns of inputs are used for adjusting each QQPSK modulator 16-i (i=1 to N) up to the Y combining element 15-N.

(I) All Xᵢ are “1” while all Yᵢ are “0.”

(II) All Xᵢ and Yᵢ are “1.”

(III) All Xᵢ and Yᵢ are “0.”

(IV) All Xᵢ are “0” while all Yᵢ are “1.”

The voltages of bits “0” and “1” to the phase modulators 164 and 165 in each QQPSK modulator 16-i are adjusted so that the output intensity ratio to these four input patterns (I), (II), (III), and (IV) is closest to 2:1:1:0. At this time, no input is given to the phase modulators 17 and 18. That is, the phase modulators 17 and 18 output the input light without changing the phase.

In a case where the above calibration method is difficult, first, when Xᵢ and Yᵢ are “0”, the phase modulators 164 and 165 in each QQPSK modulator 16-i output the light without changing the phase, and when Xᵢ and Yᵢ are “1”, the voltages of “0” and “1” of the bits Xᵢ and Yᵢ are roughly set so that the phase modulators 164 and 165 in each QQPSK modulator 16-i output the light with the phase shifted by π. Then, in response to the four input patterns (I) to (IV), the voltages of “0” and “1” of the bits Xᵢ and Yᵢ are adjusted so that the absolute amplitude values of the I component and the Q component of the output light of the Y combining element 15-N are all equal and maximized. By halving the voltages of “0” and “1” of the adjusted bits Xᵢ and Yᵢ, the same result as the above calibration method can be obtained.

To check the success or failure of calibration, it is conceivable to measure the output intensity pattern for all bit input combinations (256 combinations) and compare the output intensity pattern with the pattern in the ideal case.

The phase modulators 17 and 18 in the subsequent stage are calibrated by separately preparing an interference circuit with reference light.

In this manner, the present embodiment can achieve a high-order QAM modulator with a lower loss than in the related art.

Note that, although N is equal to 4 in the present embodiment, the present invention is not limited thereto. In the present embodiment, by setting N to a higher value, it is possible to achieve a higher-order QAM of 961QAM or higher.

### Second Embodiment

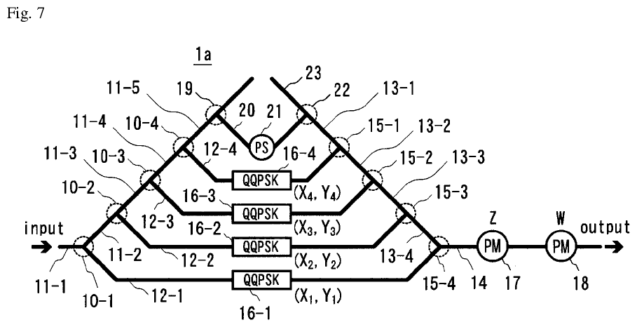

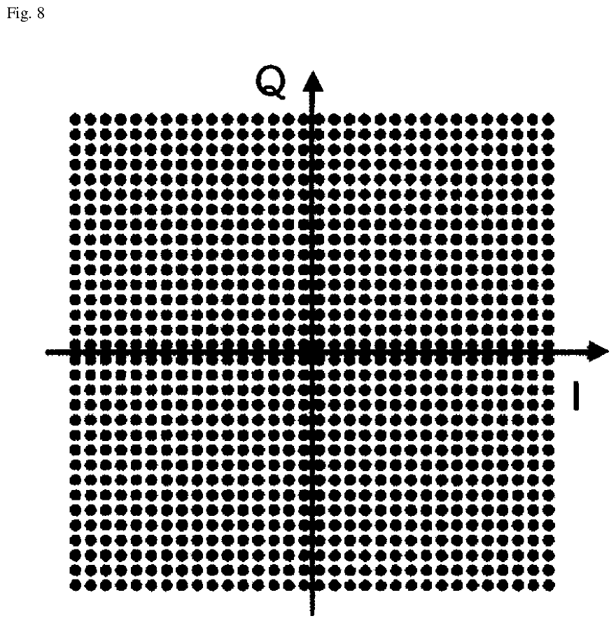

Next, a second embodiment of the present invention will be described. FIG. 7 is a block diagram illustrating a configuration of an optical IQ modulator according to the second embodiment of the present invention, and FIG. 8 is a diagram illustrating a constellation of an optical output signal of the optical I/Q modulator on an IQ plane. An optical IQ modulator 1a of the present embodiment functions as a 1024QAM modulator that generates a 1024QAM signal.

Specifically, the optical IQ modulator 1a includes Y branching elements 10-1 to 10-N (N is an integer equal to or greater than two, and is four in the present embodiment), optical waveguides 11-1 to 11-(N+1), 12-1 to 12-N, 13-1 to 13-N, and 14, he Y combining elements 15-1 to 15-N, QQPSK modulators 16-1 to 16-N, phase modulators (PM) 17 and 18, a Y branching element 19 having one input and two outputs in which light output from one of the optical output ports of the Y branching element 10-N is used as an input, an optical waveguide 20 connected to one of the optical output ports of the Y branching element 19, a phase shifter 21 provided in the optical waveguide 20, a Y combining element 22 having two inputs and one output in which one optical input port is connected to the optical waveguide 20 and an optical output port is connected to the optical waveguide 13-1, and an optical waveguide 23 connected to the other optical input port of the Y combining element 22.

The optical IQ modulator 1a of the present embodiment is obtained by adding the Y branching element 19, the optical waveguides 20 and 23, the phase shifter 21, and the Y combining element 22 to the optical IQ modulator 1 of the first embodiment.

The Y branching element 19 equally splits the continuous light output from the Y branching element 10-N and propagated through the optical waveguide 11-(N+1) into two beams of light.

The phase shifter 21 outputs the continuous light propagated through the optical waveguide 20 with the phase shifted by π/4. The Y combining element 22 combines the light propagated through the optical waveguide 20 and the light propagated through the optical waveguide 23 at an equal ratio and outputs the combined light. However, in the present embodiment, no light is input to the optical waveguide 23. Accordingly, the Y combining element 22 outputs the light output from the phase shifter 21 and propagated through the optical waveguide 20 to the optical waveguide 13-1. In this way, in the present embodiment, the light phase-shifted by the phase shifter 21 is input to the other optical input port of the Y combining element 15-1.

The phase shifter 21 is provided to make the constellation in the Y combining element 15-N of the first embodiment shifted by half the amplitude of the least significant bit (LSB) of the electrical digital signal with respect to each of the positive directions of the I-axis and the Q-axis, so that the overlap of constellations on the I-axis and Q-axis is eliminated, and as a result, a 32×32 QAM signal is generated.

The operations of the other configurations are the same as those in the first embodiment.

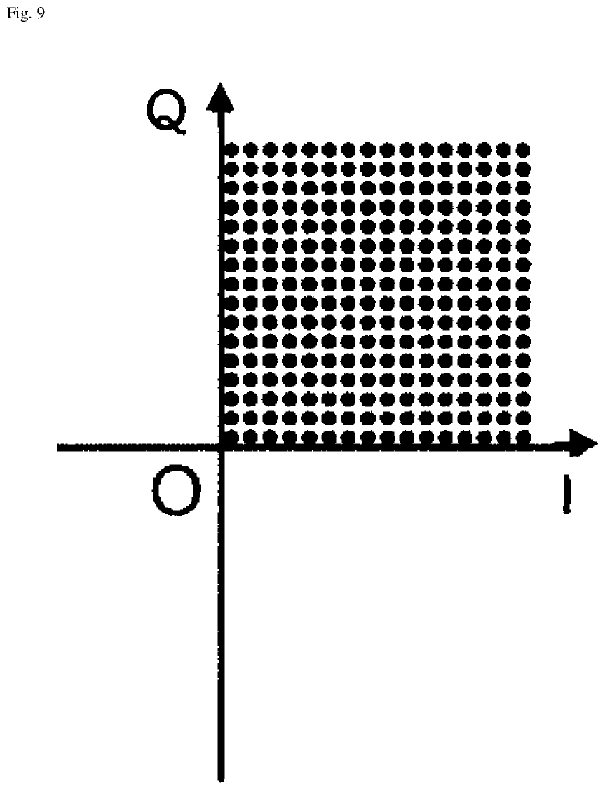

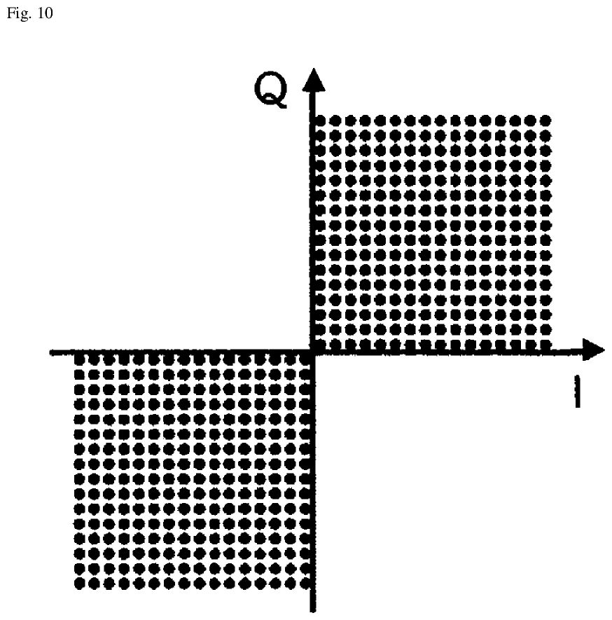

When the I component and the Q component of the output of the Y combining element 15-N of the present embodiment are coherent-detected and plotted on the IQ plane, the signal as illustrated in FIG. 9 is obtained. Additionally, when the I component and the Q component of the output of the phase modulator 17 of the present embodiment are coherent-detected and plotted on the IQ plane, the signal is obtained as illustrated in FIG. 10. When the I component and the Q component of the output of the phase modulator 18 are coherent-detected and plotted on the IQ plane, a 32×32 QAM signal with signal points being present in all quadrants is obtained as illustrated in FIG. 8. In the present embodiment, neither the I component nor the Q component becomes zero.

Although N is equal to 4 in the present embodiment as in the first embodiment, the present invention is not limited thereto. In the present embodiment, by setting N to a higher value, it is possible to achieve a higher-order QAM of 1024QAM or higher.

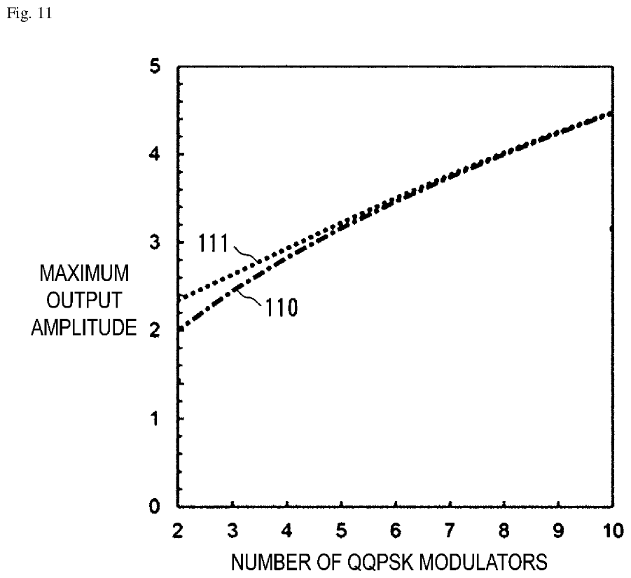

FIG. 11 illustrates the maximum output amplitudes of the optical IQ modulators 1 and 1a of the first and second embodiments with respect to the number of QQPSK modulators. The reference numeral 110 in FIG. 11 designates the amplitude of the optical IQ modulator 1, and the reference numeral 11 designates the amplitude of the optical IQ modulator 1a. The number of QQPSK modulators on the horizontal axis corresponds to half of the number of input bits (N x 2). Accordingly, this means that the larger the number of QQPSK modulators, the higher the gradation output with more bits becomes possible. In the case of an optical IQ modulator in the related art, the horizontal axis in FIG. 11 represents the number of QPSK modulators. The vertical axis in FIG. 11 represents amplitudes of the optical IQ modulators 1 and 1a normalized by the maximum output amplitude of the optical IQ modulator in the related art.

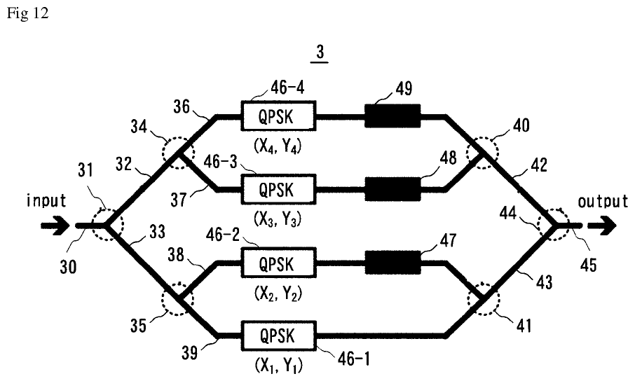

FIG. 12 is a block diagram illustrating a configuration of an optical IQ modulator in the related art. An optical IQ modulator 3 in the related art includes optical waveguides 30, 32, 33, 36 to 39, 42, 43, and 45, Y branching elements 31, 34, and 35, each of which has one input and two outputs, Y combining elements 40, 41, and 44, each of which has two inputs and one output, and QPSK modulators 46-4 to 46-1 provided at the optical waveguides 36 to 39, a fixed optical attenuator 47 with a loss of 6 dB provided at the optical waveguide 38, a fixed optical attenuator 48 with a loss of 12 dB provided at the optical waveguide 37, and a fixed optical attenuator 49 with a loss of 18 dB provided at the optical waveguide 36.

FIG. 12 illustrates an example in which the number of QPSK modulators is four (N=4), and the QPSK modulators function as a 256 QAM modulator. Because bits are not weighted at all at the branching or combining of the light in the optical IQ modulator 3 in the related art, the fixed optical attenuators 47 to 49 inserted into the optical waveguides 38 to 36 perform weighting. Thus, insertion losses increase as compared with the first and second embodiments. Also, the insertion losses further increases as the number of symbols increases.

It can be seen from FIG. 11 that both the optical IQ modulators 1 and 1a in the first and second embodiments are suitable for an increase in gradation as compared with the configuration in the related art. The second embodiment is slightly better than the first embodiment, and as the number of QQPSK modulators increases, the difference between the first embodiment and the second embodiment decreases.

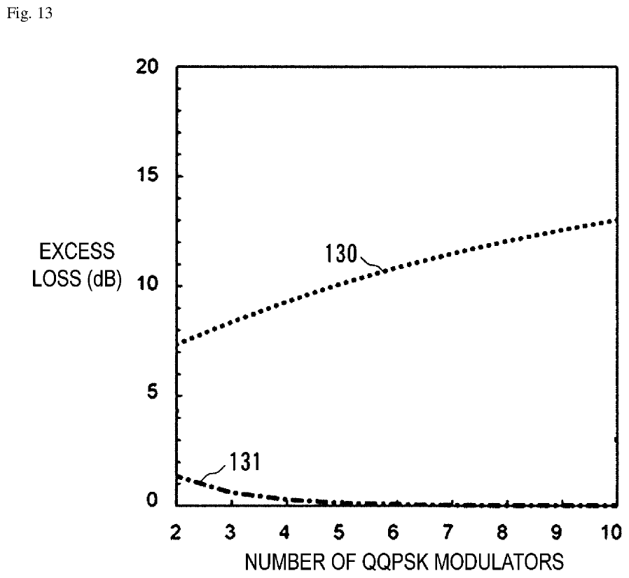

FIG. 13 is a diagram illustrating excess losses of the optical IQ modulator in the related art and the optical IQ modulator 1 with reference to an excess loss of the optical IQ modulator 1a. The reference numeral 130 in FIG. 13 designates the excess loss of the optical IQ modulator in the related art, and the reference numeral 131 designates the excess loss of the optical IQ modulator 1.

It can be seen from FIG. 13 that the loss of the optical IQ modulator in the related art increases as the number of QPSK modulators increases, whereas the losses of the optical IQ modulators 1 and 1a of the first and second embodiments decrease as the number of QQPSK modulators increases, and thus the optical IQ modulators 1 and 1a are suitable for high gradation.

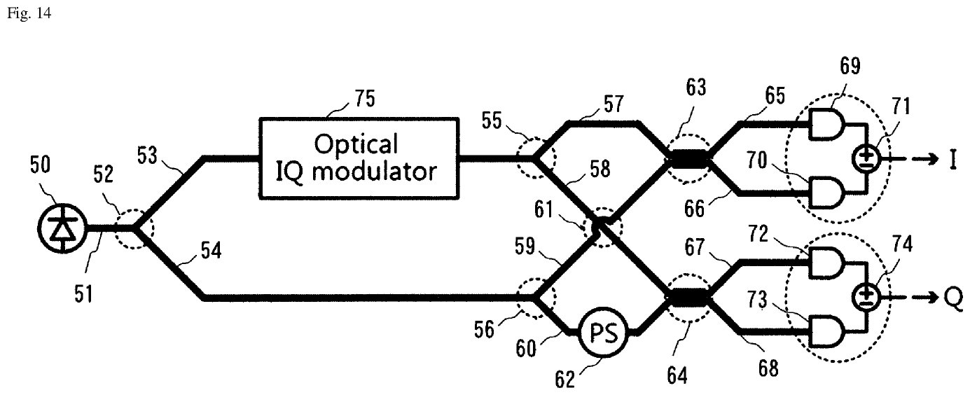

Numerical simulation for inspecting operations of the configurations of the optical IQ modulators 1 and 1a in the first and second embodiments was carried out. Here, simulation was carried out using Optisystem, which was software from Optiwave Systems Inc. A configuration of an optical circuit used for inspecting operations is illustrated in FIG. 14.

The optical circuit in FIG. 14 includes a continuous laser light source 50, optical waveguides 51, 53, 54, 57 to 60, and 65 to 68, Y branching elements 52, 55, and 56, each of which has one input and two outputs, an intersecting optical waveguide 61 three-dimensionally intersecting the optical waveguide 58 and the optical waveguide 59, a phase shifter 62 shifting the phase of light propagated through the optical waveguide 60 by π/2, a 2×2 coupler 63 combining light propagated through the optical waveguide 57 and light propagated through the optical waveguide 59, equally splitting the light into two beams of light, and outputting the two beams of light, a 2×2 coupler 64 combining light propagated through the optical waveguide 58 and the light propagated through the optical waveguide 60, equally splitting the light into two beams of light, and outputting the two beams of light, a detector 69 converting one of the output beams of light of the 2×2 coupler 63 into an electrical signal, a detector 70 converting the other output beam of light of the 2×2 coupler 63 into an electrical signal, a subtracter 71 obtaining a difference between the electrical signals output from the detectors 69 and 70, a detector 72 converting one of the output beams of light of the 2×2 coupler 64 into an electrical signal, a detector 73 converting the other output beam of light of the 2×2 coupler 64 into an electrical signal, and a subtracter 74 obtaining a difference between the electrical signals output from the detectors 72 and 73.

Any one of the optical IQ modulators 1 and 1a in the first and second embodiments is inserted into a part designated by the reference numeral 75 in the optical waveguide 53.

FIG. 14 illustrates an optical circuit in a case in which so-called coherent detection is performed. In the example in FIG. 14, the continuous light from the continuous laser light source 50 is equally split into two beams of light by the Y branching element 52, and one of the continuous beams of light is input to the optical IQ modulator. The other continuous beam of light branched by the Y branching element 52 is propagated through the optical waveguide 54, the Y branching element 56, and the optical waveguide 59 and is input as reference light to the 2×2 coupler 63.

The 2×2 coupler 63 combines the reference light and the output light of the optical IQ modulator at an equal ratio, equally splits the light into two beams of light, and outputs the two beams of light. The detectors 69 and 70 convert the two output beams of light of the 2×2 coupler 63 into electrical signals. The subtracter 71 obtains a difference between the two electrical signals output from the detectors 69 and 70. In this manner, it is possible to detect the I component using a configuration of balanced detectors (balanced receivers) including the detectors 69 and 70 and the subtracter 71.

On the other hand, the 2×2 coupler 64 combines the reference light with the phase shifted by π/2 by the phase shifter 62 and the output light of the optical IQ modulator at an equal ratio, equally splits the light into two beams of light, and outputs the two beams of light. The detectors 72 and 73 convert the two output beams of light of the 2×2 coupler 64 into electrical signals. The subtracter 74 obtains a difference between the two electrical signals output from the detectors 72 and 73. In this manner, it is possible to detect the Q component using a configuration of balanced detectors including the detectors 72 and 73 and the subtracter 74.

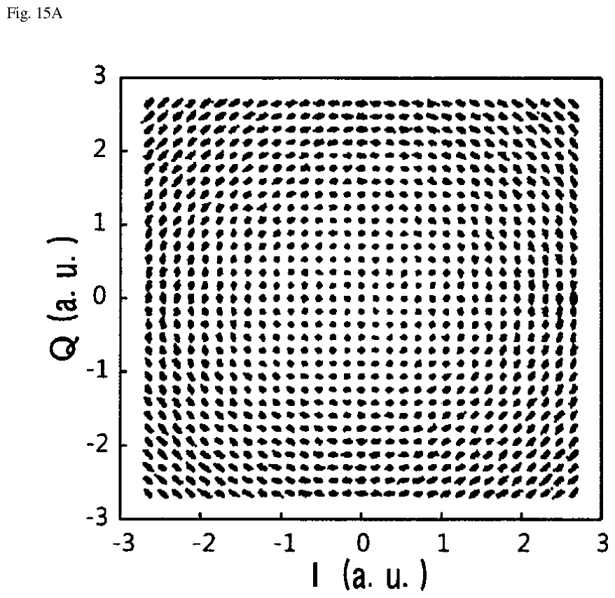

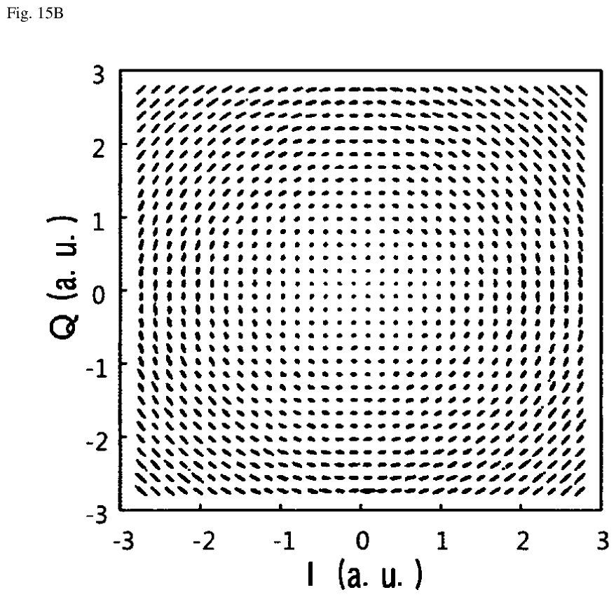

FIG. 15A is a diagram illustrating a constellation of a simulation result on an IQ plane when the optical IQ modulator 1 of the first embodiment is inserted into the optical waveguide 53 of the optical circuit of FIG. 14. FIG. 15B is a diagram illustrating a constellation of a simulation result on an IQ plane when the optical IQ modulator 1a of the second embodiment is inserted into the optical waveguide 53 of the optical circuit of FIG. 14. In the examples of FIGS. 15A and 15B, N is equal to four.

In the simulation using the optical circuit in FIG. 14, the symbol rate is set to 10 GS/s. In the laser light source 50, a wavelength is set to 1550 nm and light intensity is set to 10 dBm. A noise spectral power density (NSPD) of each phase modulator used in the optical IQ modulators 1 and 1a is −130 dBm/Hz. PD-40 which is an InGaAs-based optical detector manufactured by Optilab, LLC is assumed to be used as each of the detectors 69, 70, 72, and 73. The optical detector has conversion efficiency of 0.8 A/W and has a radio frequency (RF) band of 40 GHz. Also, an insertion loss of all passive elements is assumed to be 0 dB.

Table 1 shows the simulation results of the first and second embodiments.

TABLE 1

| | FIRST | SECOND |
|---|---|---|
| | EMBODIMENT | EMBODIMENT |
| NUMBER OF SIGNAL | 31 × 31 | 32 × 32 |
| POINTS | | |
| MAXIMUM OUTPUT | UP TO 3.8 | UP TO 3.9 |
| AMPLITUDE (a.u.) | | |
| ZERO POINT | PRESENT | ABSENT |
| SIGNAL DISTRIBUTION | UNEVEN | UNEVEN |

In the first and second embodiments, the output amplitudes can be increased. However, a total of three stages of the phase modulators, namely, the phase modulator 164 or 165 and the phase modulators 17 and 18, are cascade-connected, and thus there is a bias in the standard deviation a of the signal distribution.

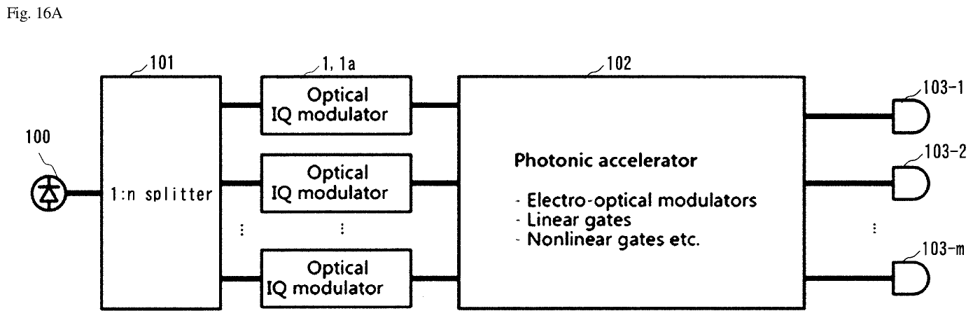

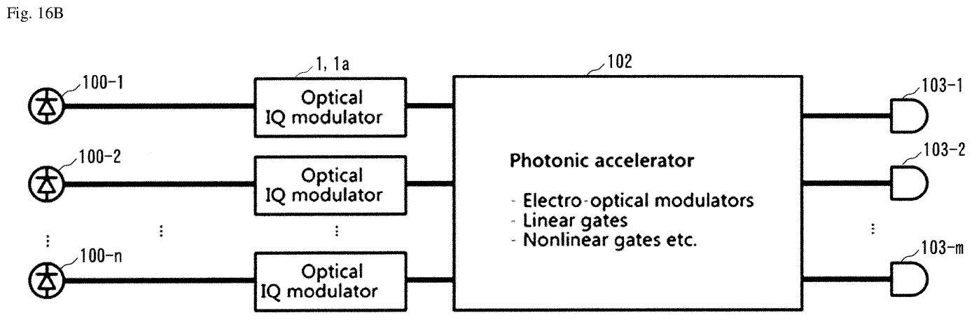

FIGS. 16A and 16B illustrate utilization forms in a case in which the optical IQ modulators 1 and 1a in the first and second embodiments are used in optical accelerators. In the examples of FIGS. 16A and 16B, the optical IQ modulators 1 and 1a, the number of which corresponds to the number n of inputs (n is an integer equal to or greater than two) of an optical accelerator circuit 102, are connected.

As illustrated in FIG. 16A, it is possible to perform a coherent operation such as a stable vector operation by supplying the same light to each of the optical IQ modulators using a 1:n splitter 101 in a case in which the number of optical sources 100 is one. However, there is a problem that intensity of the light input to each of the optical IQ modulators decreases.

On the other hand, in a case in which n light sources 100-1 to 100-n are used as illustrated in FIG. 16B, intensity of the light input to each of the optical IQ modulators increases. However, there is a problem that monitoring of a wavelength of each light source, feedback correction of the wavelength, and the like are needed.

A result of the operation performed by the optical accelerator circuit 102 is extracted by m (m is an integer equal to or greater than two) detectors 103-1 to 103-m. Alternatively, m sets of balanced detectors may be used, or a combination of a single detector 103 and balanced detectors may be used.

### INDUSTRIAL APPLICABILITY

Embodiments of the present invention can be applied to an optical IQ modulator.

### REFERENCE SIGNS LIST

1 Optical IQ modulator
10, 19, 160 Y branching element
11 to 14, 20, 23, 161, 162 Optical waveguide
15, 22, 163 Y combining element
16 QQPSK modulator
17, 18, 164, 165 Phase modulator
21, 166 Phase shifter.

1-4. (canceled)

5. An optical IQ modulator comprising:
N first Y branching elements, N being an integer equal to or greater than two, each of the N first Y branching elements having one input and two outputs and being configured to equally split input light into two beams of light;
N first modulators, each of the N first modulators being configured to perform QPSK modulation on a corresponding one of N continuous beams of light branched by the N first Y branching elements to generate signal light;
N first Y combining elements, each of the N first Y combining elements having:
two inputs and one output and being configured to use the signal light generated by a corresponding one of the N first modulators as an input;
a second modulator configured to perform phase modulation on signal light output from a most downstream one of the N first Y combining elements in accordance with a first drive signal; and
a third modulator configured to perform phase modulation on signal light output from the second modulator in accordance with a second drive signal,
wherein the N first Y branching elements are cascade-connected such that each of the N first Y branching elements except for a most upstream one of the N first Y branching elements are configured to receive, as an input, light output from a first optical output port of two optical output ports of an upstream one of the N first Y branching elements,
wherein the most upstream one of the N first branching elements is configured to receive, as an input, a single continuous beam of light;
wherein output light obtained from a second optical output port of the two optical output ports of each of the N first Y branching elements is used as input light to a corresponding one of the N first modulators,
wherein each of the N first modulators performs QPSK modulation on the corresponding one of the N continuous beams of light in accordance with a bit for generating an I component and a bit for generating a Q component in an N×2-bit electrical digital signal,
wherein the N first Y combining elements are cascade-connected such that each of the N first Y combining elements except for a most upstream one of the N first Y combining elements is configured to receive, as input light to a first optical input port, light output from an optical output port of an upstream one of the N first Y combining elements, and each of the N first Y combining elements is configured to use, as input light to a second optical input port, signal light generated by a corresponding one of the N first modulators, and
wherein output light obtained from the third modulator is output as QAM signal light.

6. The optical IQ modulator according to claim 5, wherein:
each of the N first modulators is configured to perform QPSK modulation on a corresponding one of the N continuous beams of light branched by the N first Y branching elements such that four signal points are present in a first quadrant on an IQ plane;
the second modulator is configured to perform phase modulation on the signal light output from the most downstream first Y combining element in accordance with the first drive signal for selecting between no rotation and 180-degree rotation of the signal on the IQ plane; and
the third modulator is configured to perform phase modulation on the signal light output from the second modulator in accordance with the second drive signal for selecting between no rotation and 90-degree rotation of the signal on the IQ plane.

7. The optical IQ modulator according to claim 5, further comprising:
a second Y branching element having one input and two outputs and configured to equally split continuous light output from a most downstream one of the N first Y branching elements into two beams of light;
a first phase shifter configured to shift a phase of continuous light branched by the second Y branching element by π/4; and
a second Y combining element having two inputs and one output and configured to input output light of the first phase shifter to the first optical input port of the most upstream first Y combining element.

8. The optical IQ modulator according to claim 5, wherein:
each of the N first modulators includes:
a third Y branching element having one input and two outputs and configured to equally split input light into two beams of light,
a fourth modulator configured to perform phase modulation a continuous beam of light branched by the third Y branching element in accordance with the bit for generating the I component in the N×2-bit electrical digital signal,
a fifth modulator configured to perform phase modulation on the other one of the continuous beams of light branched by the third Y branching element in accordance with the bit for generating the Q component in the N×2-bit electrical digital signal,
a second phase shifter configured to shift a phase of output light of the fifth modulator by π/2, and
a third Y combining element having two inputs and one output and configured to combine output light from the fourth modulator and output light from the second phase shifter and output combined light.

9. An optical IQ modulator comprising:
N first Y branching elements, N being an integer equal to or greater than two, each of the N first Y branching elements having one input and two outputs and being configured to split input light into two beams of light;
N first modulators, each of the N first modulators being configured to perform QPSK modulation on a corresponding one of N beams of light branched by the N first Y branching elements to generate signal light;
N first Y combining elements, each of the N first Y combining elements having:
two inputs and one output and being configured to receive the signal light generated by a corresponding one of the N first modulators as an input; and
a second modulator configured to perform phase modulation on signal light output from a most downstream one of the N first Y combining elements in accordance with a first drive signal,
wherein the N first Y branching elements are cascade-connected such that each of the N first Y branching elements except for a most upstream one of the N first Y branching elements are configured to receive, as an input, light output from a first optical output port of two optical output ports of an upstream one of the N first Y branching elements,
wherein output light obtained from a second optical output port of the two optical output ports of each of the N first Y branching elements is used as input light to a corresponding one of the N first modulators,
wherein each of the N first modulators performs QPSK modulation on the corresponding one of the N beams of light in accordance with a bit for generating an I component and a bit for generating a Q component in an N×2-bit electrical digital signal, and
wherein the N first Y combining elements are cascade-connected such that each of the N first Y combining elements except for a most upstream one of the N first Y combining elements is configured to receive, as input light to a first optical input port, light output from an optical output port of an upstream one of the N first Y combining elements, and each of the N first Y combining elements is configured to use, as input light to a second optical input port, signal light generated by a corresponding one of the N first modulators.

10. The optical IQ modulator according to claim 9, wherein each of the N first Y combining elements further comprises a third modulator configured to perform phase modulation on signal light output from the second modulator in accordance with a second drive signal, and wherein output light obtained from the third modulator is output as QAM signal light.

11. The optical IQ modulator according to claim 10, wherein:
each of the N first modulators is configured to perform QPSK modulation on a corresponding one of the N beams of light branched by the N first Y branching elements such that four signal points are present in a first quadrant on an IQ plane;
the second modulator is configured to perform phase modulation on the signal light output from the most downstream first Y combining element in accordance with the first drive signal for selecting between no rotation and 180-degree rotation of the signal on the IQ plane; and
the third modulator is configured to perform phase modulation on the signal light output from the second modulator in accordance with the second drive signal for selecting between no rotation and 90-degree rotation of the signal on the IQ plane.

12. The optical IQ modulator according to claim 9, further comprising:
a second Y branching element having one input and two outputs and configured to equally split light output from a most downstream one of the N first Y branching elements into two beams of light;
a first phase shifter configured to shift a phase of light branched by the second Y branching element by π/4; and
a second Y combining element having two inputs and one output and configured to input output light of the first phase shifter to the first optical input port of the most upstream first Y combining element.

13. The optical IQ modulator according to claim 9, wherein:
each of the N first modulators includes:
a third Y branching element having one input and two outputs and configured to equally split input light into two beams of light,
a fourth modulator configured to perform phase modulation a beam of light branched by the third Y branching element in accordance with the bit for generating the I component in the N×2-bit electrical digital signal,
a fifth modulator configured to perform phase modulation on the other one of the beams of light branched by the third Y branching element in accordance with the bit for generating the Q component in the N×2-bit electrical digital signal,
a second phase shifter configured to shift a phase of output light of the fifth modulator by π/2, and
a third Y combining element having two inputs and one output and configured to combine output light from the fourth modulator and output light from the second phase shifter and output combined light.
